(19) United States
(12) Patent Application Publication
(10) Pub. No.: US 2013/0031507 A1
(43) Pub. Date: Jan. 31, 2013

(54) SYSTEMS AND METHODS FOR SCROLLING A DOCUMENT BY PROVIDING VISUAL FEEDBACK OF A TRANSITION BETWEEN PORTIONS OF THE DOCUMENT

(71) Applicant: Moses George, Sunnyvale, CA (US)

(72) Inventor: Moses George, Sunnyvale, CA (US)

(21) Appl. No.: 13/193,229

(22) Filed: Jul. 28, 2011

(51) Int. Cl. G06F 3/048

(52) U.S. Cl. 715/784

(57) ABSTRACT

Systems and methods for navigating a document by scrolling are provided. A first portion of the document is displayed within a display area. A user action to scroll the document is determined. A second portion of the document is determined. A visual feedback of a transition between the first portion and the second portion along a coordinate plane and an axis of rotation is provided within the display area. The second portion of the document is displayed within the display area.

### I. BACKGROUND

Scrolling functionality may be provided in a user interface, so as to facilitate the display of documents that are too large to be effectively presented on a display device or within a particular window on a display device. Typically, a portion of the document is shown within a display area such as a window. The user inputs a command to cause the display to change so that a different portion of the document is displayed. The user can input the command by manipulating a scrollbar or by any other input means, such as for example, a menu command, keyboard command, or the like. Scrolling can take place in one dimension (such as vertical scrolling in a text document) or in two dimensions (such as horizontal and vertical scrolling for an image document).

Scrolling can be initiated using any input device, such as dragging a scrollbar thumb, using up and down arrow keys on a keyboard, scroll wheel, rocker switch, five-way navigation button, or the like. Such command input mechanisms may cause a selection or insertion point to move within the onscreen portion of the document, and/or may cause the document to scroll line-by-line when the top or bottom of the on-screen portion is approached or reached.

### II. BRIEF DESCRIPTION OF THE DRAWINGS

The present disclosure may be better understood and its numerous features and advantages made apparent by referencing the accompanying drawings.

FIG. 1 is a block diagram of an architecture of a mobile device in accordance with an embodiment.

FIG. 2A is a process flow diagram for navigating a document by scrolling in accordance with an embodiment.

FIG. 2B is a process flow diagram for determining a second portion of a document for display in accordance with an embodiment.

FIG. 2C is a process flow diagram for transitioning between a first portion of a document and a second portion of the document in a display area in accordance with an embodiment.

FIGS. 3A-3B are diagrams illustrating navigation of a document by incremental scrolling using a touchscreen in accordance with an embodiment.

FIGS. 4A-4B are diagrams illustrating an incremental scrolling operation in accordance with an embodiment.

FIGS. 5A-5B are diagrams illustrating a conceptual representation of a document in accordance with an embodiment.

FIGS. 6A-6D are screenshots illustrating a transition of a first portion of a document to a second portion of a document in accordance with an embodiment.

FIG. 7 illustrates a computer system in which an embodiment may be implemented.

### III. DETAILED DESCRIPTION

As mobile computing devices, such as smart phones, become more advanced there is a desire to increase the range of functions made available to users. However, the amount of available space on many of these devices is limited as users demand greater portability. In an effort to provide greater screen space, some interfaces have been moved on-screen. Screen space on a mobile device is similarly limited, and as such it is challenging to provide the full range of functions that are desired by users.

One such function that is often limited due to the physical constraints on the device is scrolling through a document on a page-by-page or multi-page bases. The absence of such a feature may provide challenges to the user, especially when parsing long documents. Typically, line-by-line scrolling can be accomplished by swiping a finger in multiple successions on a touch screen. This may be cumbersome for the user when dealing with a large document, such as an email list or list of contacts. More advanced scrolling methodologies provide a search function or a navigation control bar to jump to a relevant part of a list. For example, a contacts list may include a navigation control bar that provides letters of the alphabet as an index into the larger list. However, this requires the document to be ordered or otherwise sorted according to a characteristic that is useful to the user of the mobile device. Moreover, the navigation control bar occupies valuable screen space. Searching requires that the user perform additional steps to locate another part of the document.

As used herein, a “document” refers to any electronically displayable content item, such as a computer file. Examples of documents include lists of emails, individual emails, contacts lists, graphics-based documents, launchers including several icons representing applications that can be opened by the user, word processing documents, websites, text documents, spreadsheets, drawings, photographs, and the like. As used herein, “display area” refers to a window, pane, screen, or other area on a visual output device that is capable of displaying at least a portion of a document. The term “displayed content” or “displayed portion” refers to that part of a document that is currently being displayed within a display area.

As used herein, “scrolling operation” or “scrolling” refers to any single unit of action that causes the display area to increment through the document (e.g., in one dimension or multiple dimensions) and change the content being displayed therein, from a first displayed portion of a document to a second displayed portion of the same document. The amount of the increment is either by multiple units (e.g., items, lines, elements, etc.) in the document or by a percentage of the size of the document. The size of the document is measured according to the dimension(s) through which the increments occur. Scrolling by incrementing the document effectively skips a number n of units (where n>1) in the document from being displayed. As such, the incremental scrolling operation is not line-by-line.

Systems and methods for navigating a document by scrolling are provided. A first portion of the document is displayed within a display area of the mobile computing device. A user action to scroll the document is determined. A second portion of the document is determined. A visual feedback of a transition between the first portion and the second portion along a coordinate plane and an axis of rotation is provided within the display area. The second portion of the document is displayed within the display area.

This allows a user to get to a later part of the document quickly by using a specified gesture. No screen space is occupied by enabling this navigation control. Furthermore, the transition animation that is provided on the display area of the mobile device provides the user with visual feedback that the scrolling action is underway. For example, after providing a diagonal flick gesture on a touch screen, it appears to the user that the document is represented on a virtual wheel and that the wheel is being tilted and rotated in order to show another part of the document, as a result of the scroll.

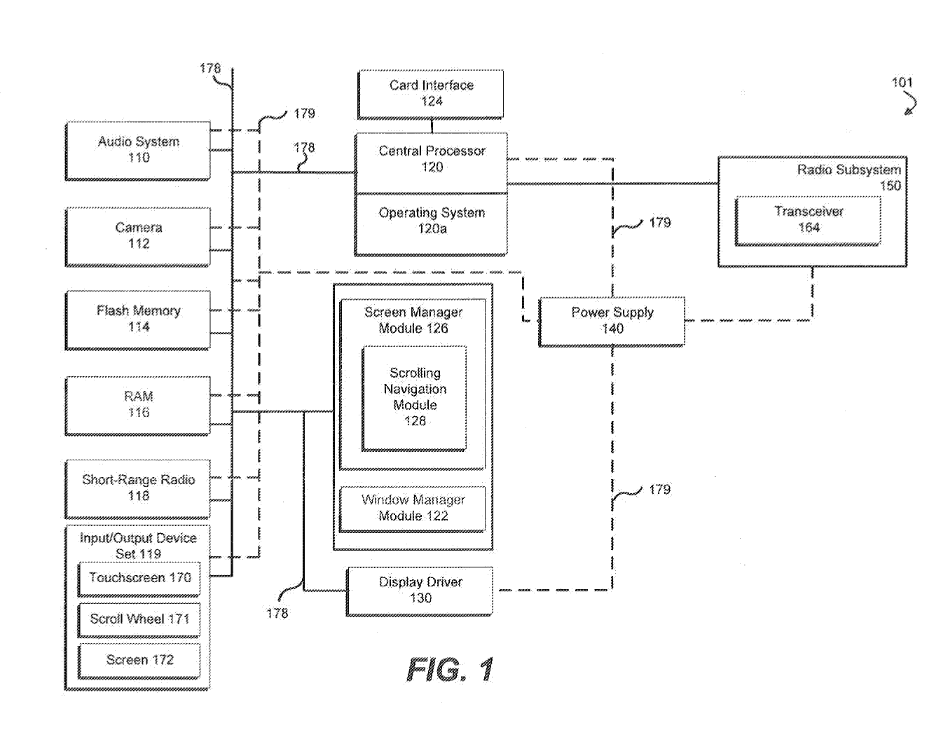

FIG. 1 is a block diagram of an architecture of a mobile computing device 101, which is shown as, but not limited to, a device with telephonic functionality, in accordance with an embodiment. Mobile computing device 101 may be a mobile telephone, a personal digital assistant, a smartphone, a handheld computer, or other mobile computing device.

Mobile computing device 101 includes a central processor 120, a power supply 140, and a radio subsystem 150.

The central processor 120 is configured for operation with a computer operating system 120a. The operating system is an interface between hardware and an application, with which a user typically interfaces. The operating system is responsible for the management and coordination of activities and the sharing of resources of the mobile computing device 101. The operating system provides a host environment for applications that are run on the mobile computing device 101. As a host, one of the purposes of an operating system is to handle the details of the operation of the mobile computing device 101. Examples of an operating system (“OS”) include PALM OS and HP WEBOS, MICROSOFT WINDOWS (including WINDOWS 7, WINDOWS CE, and WINDOWS MOBILE), SYMBIAN OS, RIM BLACKBERRY OS, APPLE OS (including MAC OS and IPHONE OS), GOOGLE OS (CHROME or ANDROID), and LINUX.

The central processor 120 communicates with an audio system 110, camera 112, flash memory 114, RAM 116, a short range radio module 118 (e.g., Bluetooth, Wireless Fidelity (WiFi) component (e.g., IEEE 802.11)), and an input/output device set 119. The central processor 120 communicatively couples these various components or modules through a data line (or bus) 178. The power supply 140 powers central processor 120, radio subsystem 150 and a display driver 130 (which may be contact- or inductive-sensitive). The power supply 140 may correspond to a direct current source (e.g., a battery pack, including rechargeable) or an alternating current (AC) source. The power supply 140 powers the various components through a power line (or bus) 179.

The central processor 120 communicates with applications executing within mobile computing device 101 through the operating system 120a. In addition, intermediary components, for example, a window manager module 122 and a screen manager module 126, provide additional communication channels between the central processor 120 and operating system 120 and system components, for example, the display driver 130.

In one embodiment, the window manager 122 comprises a software or firmware module that includes instructions that initialize a virtual display space stored in the RAM 116 and/or the flash memory 114. The screen manager 126 comprises a software or firmware module that includes instructions that manages content displayed on a screen of mobile computing device 101.

It is noted that screen manager module 126 is configured to interface with input/output device set 119 and applications, such as, but not limited to, calendars, phone lists, task lists, notepads, calculator applications, spreadsheets, games, and a phone application or messaging application. In turn, these applications may interface with the radio subsystem.

The screen manager 126 includes a scrolling navigation module 128 which comprises a software or firmware module that includes instructions that provide advanced scrolling operations. More specifically, the scrolling navigation module includes instructions that display a first portion of a document on the screen of mobile computing device 101, determine a scrolling gesture, determine a directional component of the gesture, determine a second portion of the document, provide visual feedback to indicate that scrolling is in progress, and display the second portion of the document on the screen of mobile computing device 101.

Mobile computing device 101 further includes an input/output device set 119. Specifically, input/output device set 119 includes a touchscreen 170 and scroll wheel 171 as its input devices, and screen 172 as its output device. An input device of input/output device set 119 is configured to receive physical input signals, such as a gesture made by a user and to detect whether the input signal is a request for navigating through the document by scrolling. Furthermore, input/output device set 119 is configured to interface with screen manager module 126.

In one embodiment, central processor 120 executes logic (e.g., by way of programming, code, or instructions) corresponding to executing applications. It is noted that numerous other components and variations are possible to the hardware architecture of the mobile computing device 101, thus an embodiment such as shown by FIG. 1 is illustrative of one implementation for an embodiment.

Radio subsystem 150 includes a transceiver 164. Transceiver 164 may be two separate components for transmitting and receiving signals or a single component for both transmitting and receiving signals. In either instance, it is referenced as transceiver 164. The receiver portion of the transceiver 164 communicatively couples with a radio signal input of device 101, e.g., an antenna.

While other components may be provided with the radio subsystem 150, the basic components shown provide the ability for the mobile computing device to perform radio-frequency communications, including telephonic communications. A radio processor may communicate with central processor 120 using the data line (or bus) 178.

The card interface 124 is adapted to communicate, wirelessly or wired, with external accessories (or peripherals), for example, media cards inserted into the expansion slot (not shown). The card interface 124 transmits data and/or instructions between central processor 120 and an accessory, e.g., an expansion card or media card, coupled within the expansion slot. The card interface 124 also transmits control signals from central processor 120 to the expansion slot to configure the accessory. It is noted that the card interface 124 is described with respect to an expansion card or media card; it also may be structurally configured to couple with other types of devices external to device 101, for example, an inductive charging station for the power supply 140 or a printing device.

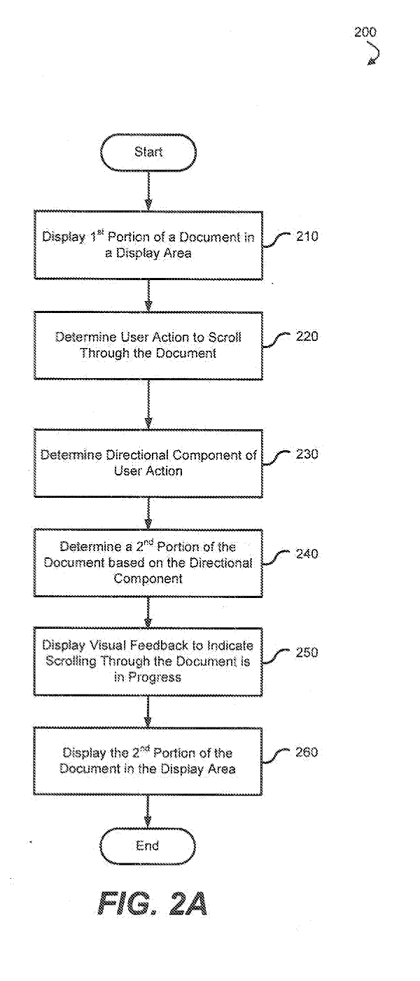

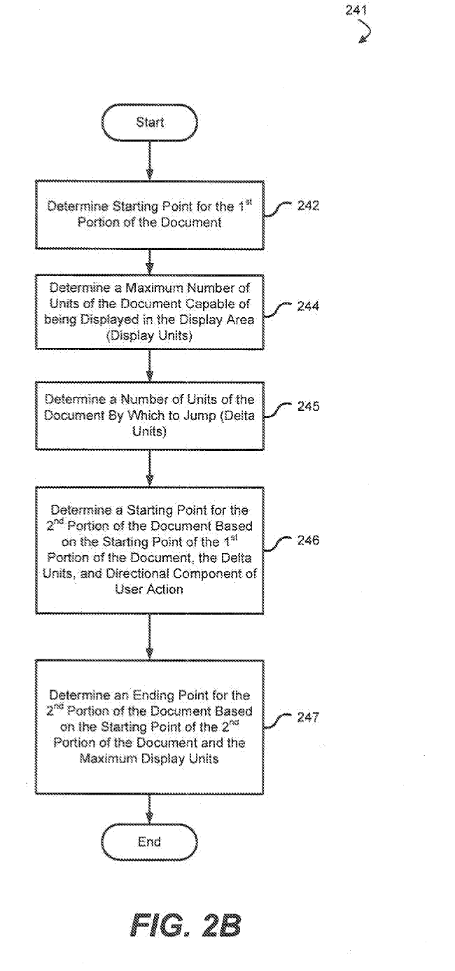

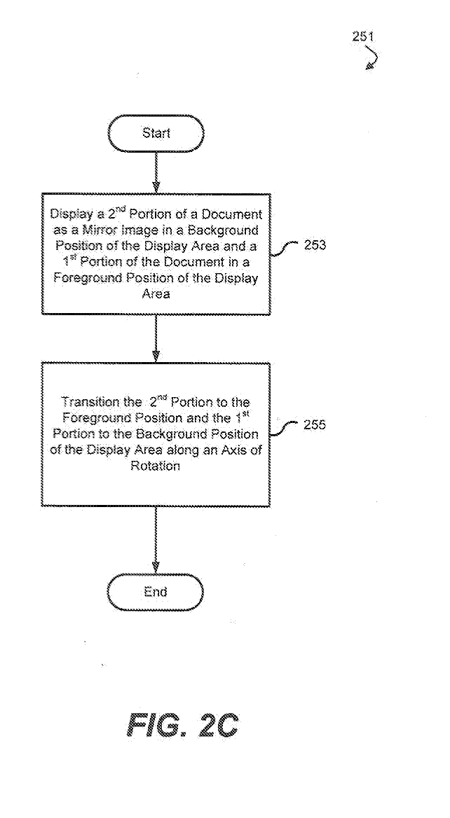

FIG. 2A is a process flow diagram for navigating a document by scrolling in accordance with an embodiment. The depicted process flow 200 may be carried out by execution of sequences of executable instructions. In another embodiment, various portions of the process flow 200 are carried out by components of a mobile device, an arrangement of hardware logic, e.g., an Application-Specific Integrated Circuit (ASIC), etc. For example, blocks of process flow 200 may be performed by execution of sequences of executable instructions in a scrolling navigation module and/or an input/output device system of the mobile device.

In one embodiment, process flow 200 describes a process for navigating through a document and displaying a visual feedback indicating a scrolling operation is in progress, before finally displaying a second portion of the document.

At step 210, a first portion of a document is displayed (“first displayed portion”) in a display area. For example, an email inbox includes a list of email messages that are organized in the inbox. Email lists have the potential of being quite long and too large to be effectively presented in its entirety on a display of the mobile device. Typically, a portion of the email list is shown in a display area, such as a window in a screen. As used herein, the first displayed portion is the part of the document that is displayed before a user command causes the display to change such that a different portion of the document is displayed. Any portion of the document that is shown is limited by the size of the display area.

At step 220, a user action to scroll through the document is determined. For example, a user provides a gesture using a touchscreen interface of the mobile device. The gesture may be recognized as a command that initiates a scrolling operation. In one embodiment, this particular gesture is intuitive to a user for performing incremental scrolling. A typical line-by-line scroll-down gesture on a touchscreen interface is a dragging finger swipe from a bottom section of the touchscreen straight upwards to a top section. In one embodiment, a gesture for an incremental scroll-down operation is a finger flick, e.g., tap-hold-drag in a diagonal direction. More specifically, a finger flick from a bottom-right section of the touchscreen to a top-left section may be recognized as the initiating command. Similarly, a gesture for an incremental scroll-down operation may be a finger flick from a top-left section of the touchscreen to a bottom-right section. It should be recognized that the particular gesture associated with any incremental scroll operation is configurable.

A directional component of the user action is determined, at step 230. In the context of one-dimensional incremental scrolling (e.g., vertical) of documents, it may be determined whether the user action is associated with a scroll-down operation or a scroll-up operation, for example, based on the orientation of the finger flick relative to the touchscreen.

At step 240, a second portion of the document is determined, based on the directional component. In one embodiment, the directional component indicates whether the user command is a scroll-up or scroll-down operation. The second portion is located further up in the document relative to the first portion, where the scroll-up operation is indicated. Similarly, the second portion is located further down in the document relative to the first portion, where the scroll-down operation is indicated. Determining a range of document units that make up the second portion is described in further detail with respect to FIG. 2B.

Visual feedback is displayed, at step 250. The visual feedback indicates that incremental scrolling through the document is in progress. In particular, the visual feedback may be an animation that is shown via the display area. The animation suggests the document is represented on a three-dimensional wheel, which rotates (e.g., spins) about an axis to provide visual access to the second portion of the document in response to the user action. The animation is described in further detail with respect to FIG. 20.

At step 260, the second portion of the document is displayed in the display area of the mobile device. As used herein, the second displayed portion is the part of the document that is displayed after a user command causes the display to change such that a different portion of the document is displayed.

As such, a single user gesture (e.g., diagonal finger flick) can cause the display area to jump to a different part of the document. As such, line-by-line scrolling may be avoided, providing a significant increase in efficiency from the vantage point of a user who is interested in a document unit that is located at a distance from a starting point in the document.

Many of the illustrations and descriptions herein refer to one-dimensional (e.g., vertical) scrolling of documents. For many of types of documents, two-dimensional scrolling (vertical and horizontal) is appropriate. Thus, although embodiments are described for illustrative purposes with respect to one-dimensional (vertical) scrolling of documents, such description is not intended to limit the scope to such particularities.

In one embodiment, the first portion is at the end of the list and the user commands a scroll-down operation, or the first portion is at the beginning of the list and the user commands a scroll-up operation. In order to allow seamless scrolling, the top and bottom of a document are logically connected, creating a loop in the document. To provide greater usability and provide orientation to the user, a tactile feedback (e.g., applying forces, vibrations, motions, etc.) or other sensory feedback (e.g., audio, visual, etc.) is output by the mobile computing, which notifies the user that the incremental scroll operation is crossing the end-to-end boundaries of the document.

FIG. 2B is a process flow diagram for determining a second portion of a document for display in accordance with an embodiment. The depicted process flow 241 may be carried out by execution of sequences of executable instructions. In another embodiment, various portions of the process flow 241 are carried out by components of a mobile device, an arrangement of hardware logic, e.g., an Application-Specific Integrated Circuit (ASIC), etc. For example, blocks of process flow 241 may be performed by execution of sequences of executable instructions in a scrolling navigation module of the mobile device.

As previously described with respect to step 240 of FIG. 2A, a second portion of the document is determined, based on the directional component(s) of the user action. In one embodiment, process flow 241 describes step 240 in further detail. In particular, process flow 241 describes determining a range of consecutive document units, which is used to generate the second portion of the document.

At step 242, the starting point for the first portion of the document is determined. The first displayed portion of the document includes a consecutive range of units (i.e., lines, items, elements, etc.) of the document. For example, lines 5-10 of a text document may be displayed in the display area before an incremental scrolling operation causes the display to change. The starting point in this example is “line 5.”

At step 244, a maximum number of units of the document capable of being displayed in the display area (i.e., display units) are determined. In one embodiment, the maximum number of lines per view page varies based on the type of display area, application, size of touchscreen, browser software limitations, etc.

At step 245, a number of units of the document by which to jump for each user action (i.e., delta units) is determined. The delta units represent the number of units which are skipped or otherwise not shown on the display area (if not already shown in the first portion) when executing an incremental scrolling operation or otherwise transitioning between the first portion and a second portion of the document. The delta units are configurable. For example, to achieve a page-by-page scrolling, the delta units may be the same value as the display units.

In another embodiment, the delta units may be determined based on a percentage of the document size along the dimension being scrolled. For example, each diagonal flick may skip or otherwise jump by 20 lines in a 100 line text document, where a jump percentage is set to 20%. By using percentages in this manner, the user can rely on reaching the end of the document in exactly five flicks.

A starting point for the second portion of the document is determined, at step 246. This starting point is determined based on the starting point of the first portion of the document, the delta units, and a directional component of the user action (as determined at step 230 of FIG. 2A). More specifically, the delta units are added to the starting point of the first portion, where the directional component indicates a scroll-down operation. The sum is the starting point for the second portion.

For example, the starting point of the first portion may be at line 50 out of 100 of a text document. The delta units indicates a jump of 20 lines, and the directional component indicates a scroll-down operation. As such, the starting point of the second portion is:

starting point of the first portion(50)+delta units(20)=line 70.

Where the directional component indicates a scroll-up operation, the value of the line jump is treated as a negative. For example, the delta units indicate a jump of 20 lines, and the starting point of the second portion is:

starting point of the first portion(50)+delta units(−20)=line 30.

If the unit value of the starting point (of the second portion) is negative, the starting point of the second portion may simply be set at the first unit of the document. In another embodiment, the negative value may be added to end of the document, simulating a seamless document where the end is connected to the beginning, forming a loop.

At step 247, an ending point for the second portion of the document is determined. The ending point is determined based on the starting point of the second portion and the maximum display units. More specifically, the ending point for the second document is the sum of the starting point (of the second portion) and the maximum display units. For example, the starting point for the second portion may be at line 70 of a text-based document. The maximum display units may be 5 lines, and as such, the end point for the second portion is at line 75 of the text-based document. The consecutive units within the range (i.e., starting point and ending point) may be used to display the second portion of the document.

FIG. 2C is a process flow diagram for transitioning between a first portion of a document and a second portion of the document in a display area in accordance with an embodiment. The depicted process flow 251 may be carried out by execution of sequences of executable instructions. In another embodiment, various portions of the process flow 251 are carried out by components of a mobile device, an arrangement of hardware logic, e.g., an Application-Specific Integrated Circuit (ASIC), etc. For example, blocks of process flow 251 may be performed by execution of sequences of executable instructions in a scrolling navigation module and/or an input/output device system of the mobile device.

As previously described with respect to step 250 of FIG. 2A, visual feedback is displayed. In one embodiment, process flow 251 describes step 250 in further detail. In particular, process flow 251 describes a transition animation that is provided on the display area of the mobile device. The animation provides the user with visual feedback that the scrolling action is underway.

At step 253, a second portion of a document is shown as a mirror image in a background position of the display area and a first portion of the document is shown in a foreground position of the display area. As such the display area shows both the first and second portions (or parts thereof) when providing the visual feedback.

At step 255, the second portion is transitioned to the foreground position and the first portion is transitioned to the background position of the display area, along an axis of rotation. In one embodiment, the transition is an animation that gives the impression that the document is represented on a three-dimensional (3D) wheel and that the wheel is being tumbled as a result of the user action, as would occur in the physical world. The document portions that comprise the background position of the display area may be represented as mirror images. This may give the impression of looking through a glass wheel and seeing data of the next incremental scroll from behind.

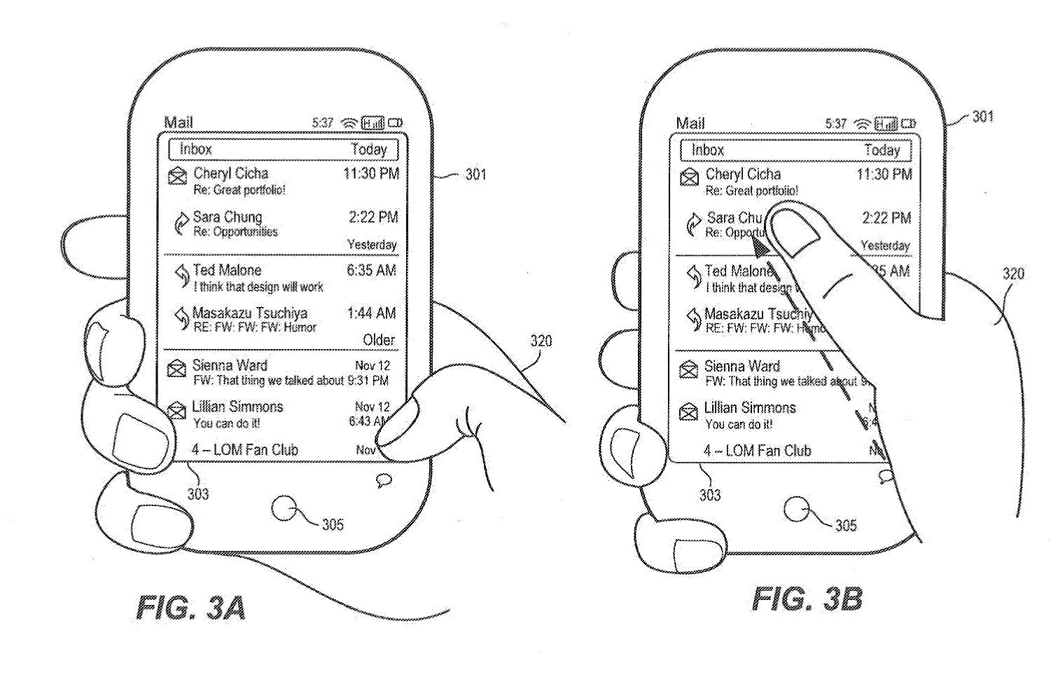

FIGS. 3A-3B are diagrams illustrating navigation of a document by incremental scrolling using a touchscreen in accordance with an embodiment. FIGS. 3A-3B show an example of a mobile computing device 301 with a display area 303. The display area 303 may include an integrated touchscreen, as shown. The display area 303 shows a list of email messages. The mobile computing device 301 has a physical button 305, which is shown for purposes of illustration. In one embodiment, physical button 305 can be used to toggle between screen modes or as a control for powering on/off device 301.

It should be recognized that a scroll position indicator is not provided for this particular email application. In general, scroll position indicators show the relative position (within a document) of the currently displayed portion of the document. Moreover, users can typically drag a scroll position indicator up or down to change the display position of a display area so that it shows different portions of the document.

Incremental scrolling, as described herein, may be leveraged by the user of device 301 to quickly access the information of interest, without performing repeated finger swipes and parsing the document line-by-line. Instead, a single gesture may be used to jump to a different portion of the document, without occupying screen space to enable the feature. As previously described, the gesture for an incremental scroll-down operation may be a dragging finger flick from a bottom-right section of a display area to a top-left section.

To further illustrate the mechanics of this gesture, FIG. 3A shows a thumb of a user's hand 320 making physical contact with the bottom-right section of display area 303. FIG. 3B shows a thumb of a user's hand 320 performing a flicking action in a diagonal direction (e.g., towards a top-left section of display area 303), while maintaining physical contact with display area 303.

A similar flicking action, but with a different directional component, may be used to indicate a command for a scroll-up operation. For example, the initial physical contact may be made at the top-left section of display area 303. The thumb may perform a diagonal flick (e.g., towards the bottom-right section of display area 303), while maintaining physical contact with display area 303.

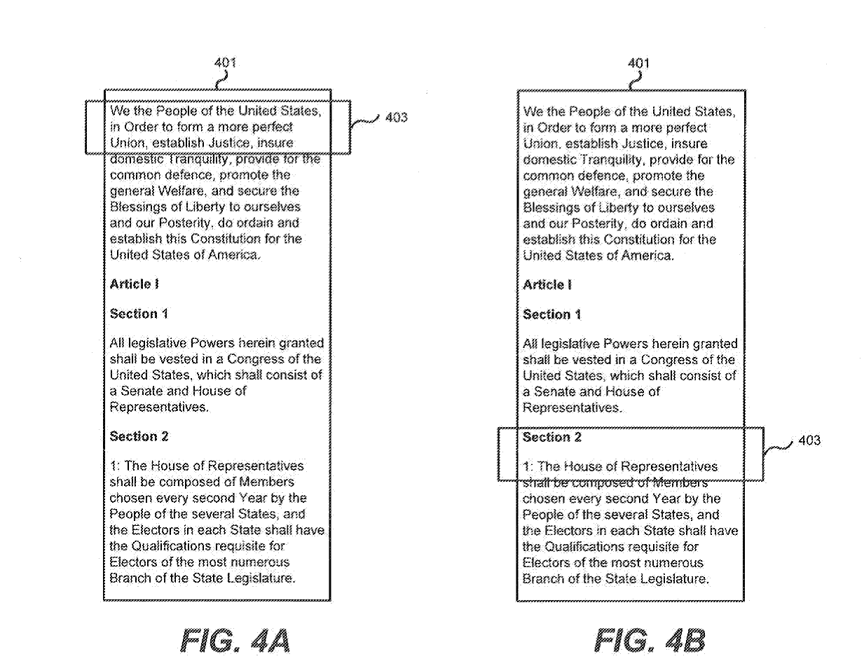

FIGS. 4A-4B are diagrams illustrating an incremental scrolling operation in accordance with an embodiment. As shown, the large size of document 401 permits a limited portion of its content to be visible at any given time in display area 403. FIG. 4A shows a portion of document 401 (i.e., a first portion) that is within display area 403. FIG. 4B shows another portion of document 401 (i.e., a second portion) that is within display area 403, as a result of a single incremental scroll-down operation. The display area 403 jumps from displaying the first portion to the second portion, for example, without showing the intermediate text lines.

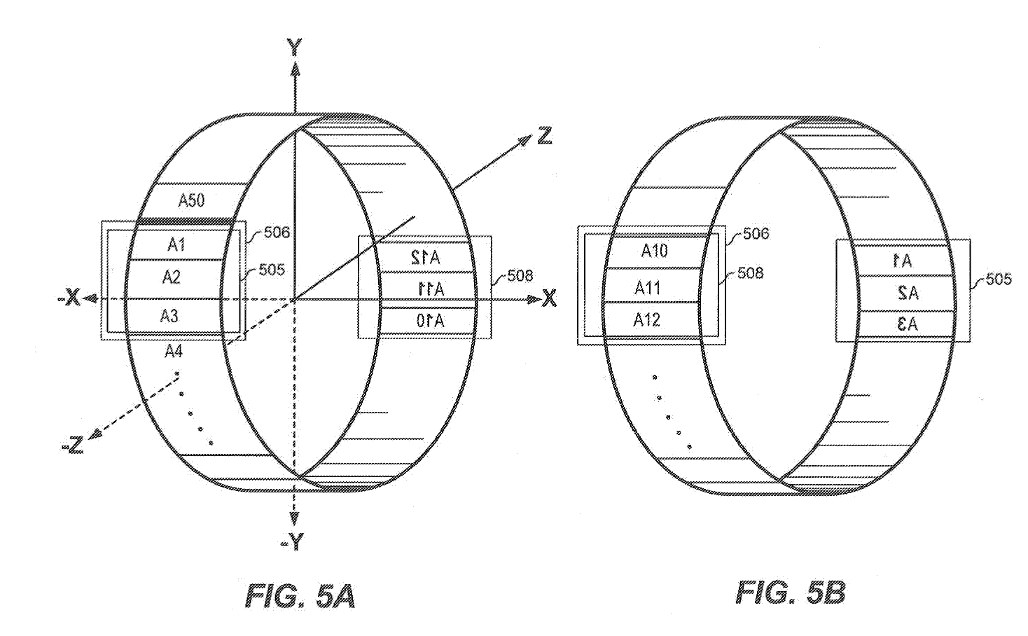

FIGS. 5A-5B are diagrams illustrating a conceptual representation of a document in accordance with an embodiment. As previously described with respect to FIG. 2A and FIG. 2C, animation is shown in a display area of a mobile device. The animation gives the impression that the document is represented on a three-dimensional (3D) wheel.

Moreover, the animation is used to provide indication to the user of the mobile device that a jump to another part of the document is occurring. When the user performs a diagonal flick on the touchscreen (indicating a command for incremental scrolling), the 3D wheel appears to tumble in response, as would occur with an actual, physical wheel.

The 3D wheel metaphor may be visualized as shown. FIG. 5A includes a diagram of the conceptual wheel. Each unit (e.g., item, line, element, etc.) from the document is represented on the wheel. A first portion of the document 505 is visually provided in a display window 506. The first portion 505 is shown as including units from the beginning of the list, but may include consecutive units from anywhere in the document. A second portion of the document 508 is determined as previously described and is shown as a mirror image. The animation can be visualized as the wheel tilting on the “X-Y” axis (i.e., coordinate plane) in response to the diagonal flick, rotating or spinning on the “Z” axis to bring the second portion 508 to the forefront, and tilting on the “X-Y” axis again to become vertically aligned with the “Y” axis.

FIG. 5B includes a diagram of the conceptual wheel after it has been tumbled in response to the user input. The second portion 508 is shown in display window 506. The first portion 508 is transitioned to the back of the wheel and is not visible on display window 506 after the incremental scroll operation has been completed. It should be mentioned that 3D modeling of a wheel or other object is not performed. The same animation may be presented regardless of which part of the wheel the data (comprising the second portion) is present.

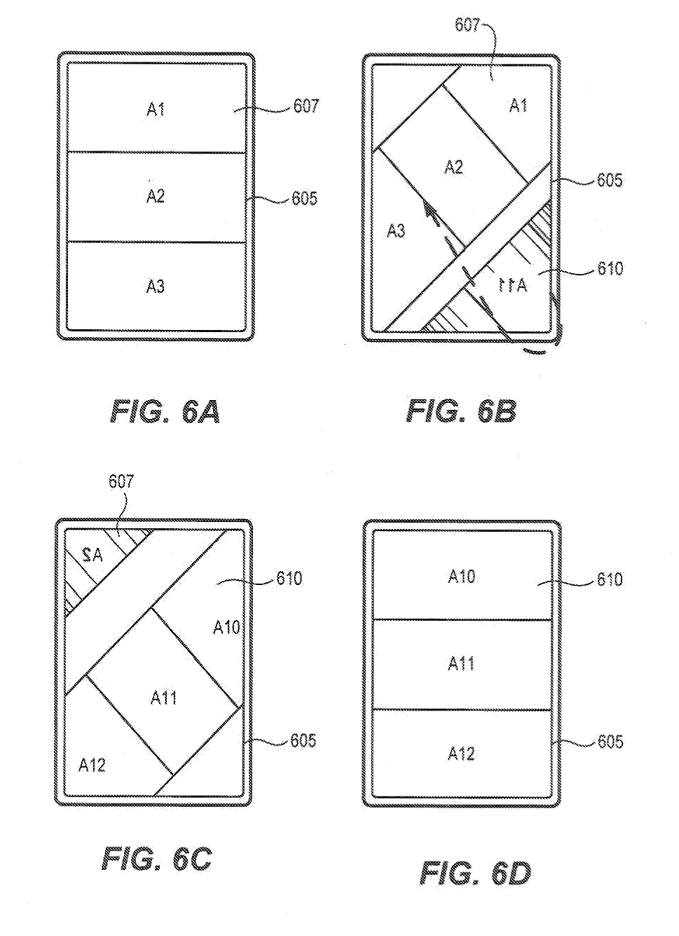

FIGS. 6A-6D are screenshots illustrating a transition of a first portion of a document to a second portion of a document in accordance with an embodiment. FIG. 6A includes a screenshot of a display area 605, as may be shown before a user action triggers the animation. Display area 605 shows a first portion of a document 607, i.e., consecutive units A1-A3. The image shown in display area 605 is oriented on an “X-Y” axis. More specifically, the image is shown vertically on a “Y” axis.

The display area 605 of FIG. 6B illustrates the beginning of a transition animation, as may occur in response to a user action. The first portion 607 of the document (or part thereof) is shown in a foreground position of display area 605, and a second portion 610 of the document is shown in a background position of display area 605. Those units in the foreground position are displayed as a front view, whereas units in the background position are displayed as a mirror image.

What is shown in display area 605 of FIG. 6B and FIG. 6C gives the impression that the document is represented on a 3D wheel (as logically represented in FIGS. 5A-5B). The wheel appears to tumble as a result of the user action. In FIG. 6B, a first motion in the transition animation shows the wheel tilting on the “X-Y” axis.

In FIG. 6C, the second portion 610 is transitioned to the foreground position and the first portion 607 is transitioned to the background position of display area 605. A second motion in the transition shows the wheel spinning around a “Z” axis to bring the second portion 610 to the foreground position.

A third motion in the transition shows the wheel tilting again on the “X-Y” axis to become vertically aligned with the “Y” axis. Once vertically aligned, in FIG. 6D, the second portion 610 is shown as fully occupying display area 605, for example, upon completion of the transition animation.

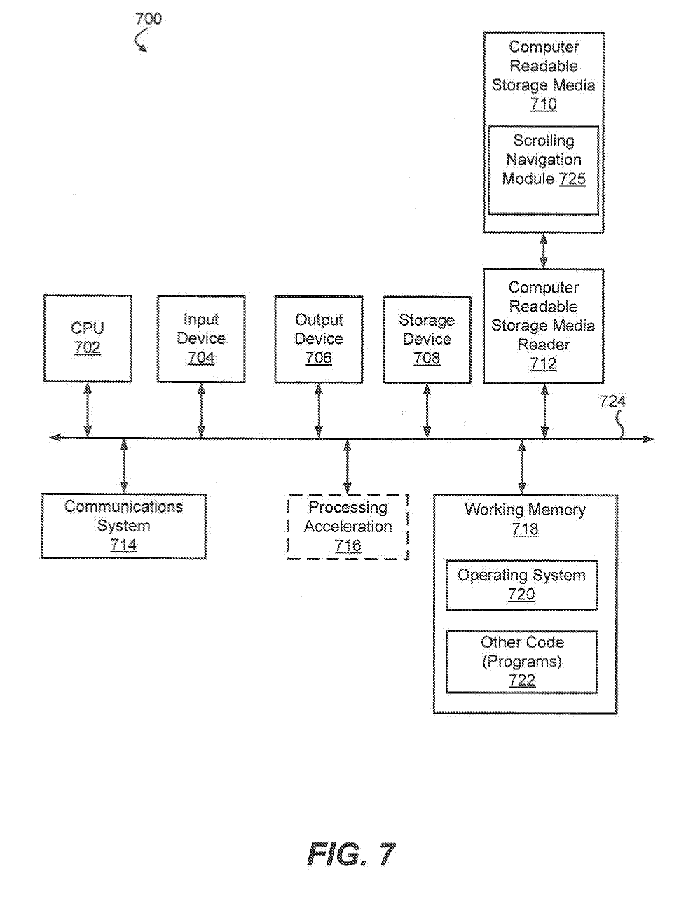

FIG. 7 illustrates a computer system in which an embodiment may be implemented. The system 700 may be used to implement any of the computer systems described above. The computer system 700 is shown comprising hardware elements that may be electrically coupled via a bus 724. The hardware elements may include at least one central processing unit (CPU) 702, at least one input device 704, and at least one output device 706. The computer system 700 may also include at least one storage device 708. By way of example, the storage device 708 can include devices such as disk drives, optical storage devices, solid-state storage device such as a random access memory (“RAM”) and/or a read-only memory (“ROM”), which can be programmable, flash-updateable and/or the like.

The computer system 700 may additionally include a computer-readable storage media reader 712, a communications system 714 (e.g., a modem, a network card (wireless or wired), an infra-red communication device, etc.), and working memory 718, which may include RAM and ROM devices as described above. In some embodiments, the computer system 700 may also include a processing acceleration unit 716, which can include a digital signal processor (DSP), a special-purpose processor, and/or the like.

The computer-readable storage media reader 712 can further be connected to a computer-readable storage medium 710, together (and in combination with storage device 708 in one embodiment) comprehensively representing remote, local, fixed, and/or removable storage devices plus any tangible non-transitory storage media, for temporarily and/or more permanently containing, storing, transmitting, and retrieving computer-readable information (e.g., instructions and data). Computer-readable storage medium 710 may be non-transitory such as hardware storage devices (e.g., RAM, ROM, EPROM (erasable programmable ROM), EEPROM (electrically erasable programmable ROM), hard drives, and flash memory). The communications system 714 may permit data to be exchanged with the network and/or any other computer described above with respect to the system 700. Computer-readable storage medium 710 includes a scrolling navigation module 725.

The computer system 700 may also comprise software elements, which are machine readable instructions, shown as being currently located within a working memory 718, including an operating system 720 and/or other code 722, such as an application program (which may be a client application, Web browser, mid-tier application, etc.). It should be recognized that alternate embodiments of a computer system 700 may have numerous variations from that described above. For example, customized hardware might also be used and/or particular elements might be implemented in hardware, software (including portable software, such as applets), or both. Further, connection to other computing devices such as network input/output devices may be employed.

The specification and drawings are, accordingly, to be regarded in an illustrative rather than a restrictive sense. It will, however, be evident that various modifications and changes may be made.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

What is claimed is:

1. A method for navigating a document by scrolling, the method comprising:
displaying, by a mobile computing device, a first portion of the document within a display area of the mobile computing device;
determining a user action to scroll the document;
determining a second portion of the document;
providing a visual feedback within the display area of a transition between the first portion and the second portion along a coordinate plane and an axis of rotation; and
displaying the second portion of the document within the display area.

2. The method of claim 1, wherein determining the second portion comprises:
determining a starting point within the document of the first portion;
determining a number of display units of the document;
determining a number of delta units of the document; and
determining a range of consecutive units of the document using the starting point of the first portion, the number of display units, and the number of delta units; and
displaying the range of consecutive units.

3. The method of claim 2, wherein the number of delta units are determined by the display units.

4. The method of claim 2, wherein the number of delta units are determined by a percentage of the size of the document.

5. The method of claim 2, wherein the delta units of the document are not displayed within the display area during the transition between the first portion and the second portion.

6. The method of claim 1, further comprising determining a directional component of the user action, wherein the second portion of the document is based on the directional component.

7. The method of claim 1, wherein the visual feedback is an animation of the transition, wherein displaying the visual feedback comprises:
displaying at least a part of the second portion as a mirror image in a background position of the display area; and
displaying at least a part of the first portion in a foreground position of the display area.

8. The method of claim 7, further comprising:
transitioning at least a part of the second portion to the foreground position; and
transitioning at least a part of the first portion to the background position.

9. The method of claim 1, wherein displaying the visual feedback comprises:
displaying animation of an image of a three-dimensional object tilting on an “X-Y” axis, wherein at least a part of the first portion is represented on a foreground position on the object, and wherein at least a part of the second portion is represented on a background position on the object.

10. The method of claim 9, wherein displaying the visual feedback further comprises:
displaying animation of the image of the object spinning along the axis of rotation, wherein the axis of rotation is a “Z” axis.

11. The method of claim 10, wherein displaying the visual feedback further comprises:
displaying animation of the image of the object tilting on an “X-Y” axis, wherein at least a part of the first portion is represented on the background position on the object, and wherein at least a part of the second portion is represented on the foreground position on the object.

12. The method of claim 1, wherein determining a user action to scroll the document comprises detecting a tap-hold-drag user gesture in a diagonal direction of a touchscreen.

13. The method of claim 1, further comprising:
determining the transition between the first portion and the second portion crosses an end-to-end boundary of the document; and
outputting sensory feedback in response to determining the transition crosses the end-to-end boundary of the document.

14. A system for navigating a document by scrolling, the system comprising:
a display screen, for displaying a first portion of the document within a display area;
an input device, for receiving a user action to perform incremental scrolling of the document;
wherein, responsive to the user action, the display screen displays a visual feedback of a transition between the first portion and a second portion of the document within the display area along a coordinate plane and an axis of rotation; and
wherein responsive to displaying the visual feedback, the display screen displays the second portion of the document within the display area.

15. The system of claim 13, wherein the display screen displays the visual feedback by displaying animation of an image of a three-dimensional object tilting on an “X-Y” axis, wherein at least a part of the first portion is represented on a foreground position on the object, and wherein at least a part of the second portion is represented on a background position on the object.

16. The system of claim 14, wherein the display screen displays the visual feedback by displaying animation of the image of the object spinning along the axis of rotation, wherein the axis of rotation is a “Z” axis

17. The system of claim 14, wherein the user action comprises a tap-hold-drag gesture in a diagonal direction.

18. A non-transitory computer-readable medium storing a plurality of instructions to control a data processor, the plurality of instructions comprising instructions that cause the data processor to:
display a first portion of a document within a display area;
determine a user action to scroll the document;
determine a second portion of the document;
provide a visual feedback of a transition between the first portion and the second portion within the display area along a coordinate plane and an axis of rotation; and
display the second portion of the document within the display area.

19. The non-transitory computer-readable medium of claim 18, wherein the instructions that cause the data processor to display the visual feedback comprise instructions that cause the data processor to:
display at least a part of the second portion as a mirror image in a background position of the display area; and
display at least a part of the first portion in a foreground position of the display area.

20. The non-transitory computer-readable medium of claim 19, wherein the instructions that cause the data processor to display the visual feedback further comprise instructions that cause the data processor to:
transition at least a part of the second portion to the foreground position; and
transition at least a part of the first portion to the background position.
